(19) United States
(12) Patent Application Publication
(10) Pub. No.: US 2014/0317977 A1
(43) Pub. Date: Oct. 30, 2014

(54) Seat saver

(71) Applicant: Kristin Di Donato, Arvada, CO (US)

(72) Inventor: Kristin Di Donato, Arvada, CO (US)

(21) Appl. No.: 13/986,346

(22) Filed: Apr. 24, 2013

(51) Int. Cl. G09F 7/20

(52) U.S. Cl. CPC G09F 7/20
USPC 40/601

(57) ABSTRACT

The Seat Saver is a sign is attached to the back of seats that can be raised to indicate that that particular seat is being saved for an individual that has not yet shown up. The sign can be pushed down behind the seat once the individual has arrived and taken the seat. The sign is to be a predetermined size and shape to allow it to be seen from all areas of the room.

### BACKGROUND OF THE INVENTION

Currently venues such as movie theaters have no way of indicating to patrons which seats are being saved for individuals who have not yet arrived to join their friends family. Individuals have been using coats, purses, and other personal items to rest on the seat indicating that the seat is being saved for an individual who has not yet arrived. Since the personal items lie low on the seats new patrons must climb stairs and approach open seats prior to seeing that the seat is being saved. The Seat Saver is a sign is attached to the back of theater seats that can be raised to indicate that that particular seat is being saved for an individual that has not yet shown up for the show. The Seat Saver is large enough to be seen from all areas allowing people to see that a seat anywhere in the theater is not available even though the seat appears to be empty. The Seat Saver can be pushed down behind the seat once the individual has arrived and taken the seat.

The Seat Saver is made of a predetermined material and in predetermined sizes. It is attached to the back of the theater seat with 2 rubber washers and a screw. One washer is placed on each side of The Seat Saver to give it traction when it is in its upright position or when it is in its lowered position behind the seat. The Seat Saver has a hole that allows an individual to grasp it in order to raise or lower it easily. The Seat Saver can be made with different colors and designs allowing the theater to advertise theater snacks, show the theater's own logo, advertise upcoming films, or remind patrons that they forgot their popcorn.

### BRIEF DESCRIPTION OF THE DRAWINGS

The invention will be better understood and the objects other than those set forth above will become apparent when consideration is given to the following detailed description thereof. Such a description makes reference to the annexed drawing wherein:

FIG. 1 is a front (lowered behind seat) view of The Seat Saver showing my new design;

FIG. 2 is front (upright) view thereof,

FIG. 3 is a back (upright) view thereof,

FIG. 4 is a side view thereof,

FIG. 5 is a front view of theater seat with The Seat Saver in upright position attached to the back of a theater seat.

### DESCRIPTION OF THE PREFERRED EMBODIMENT

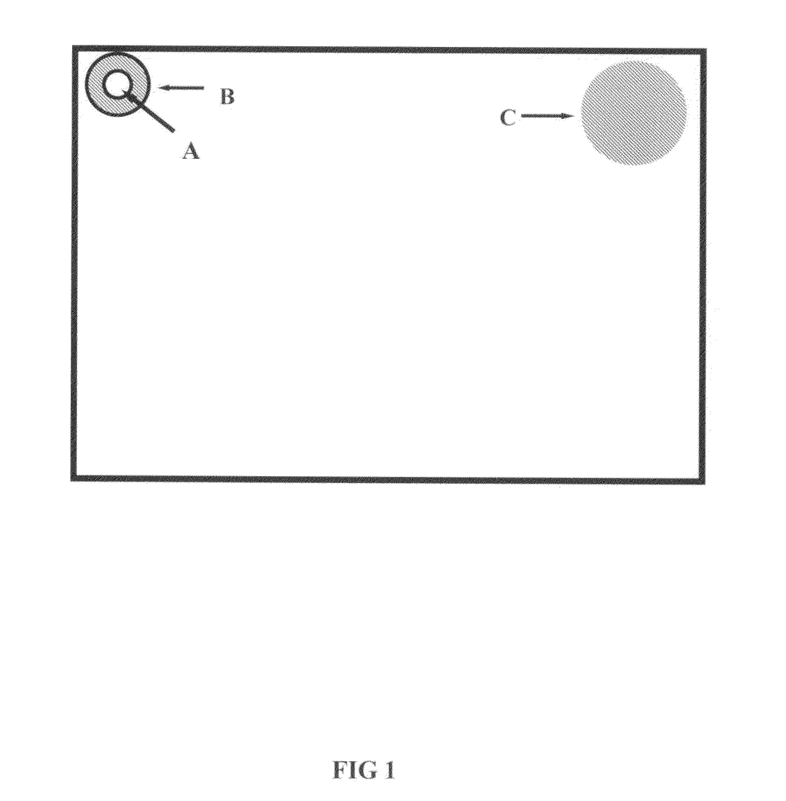

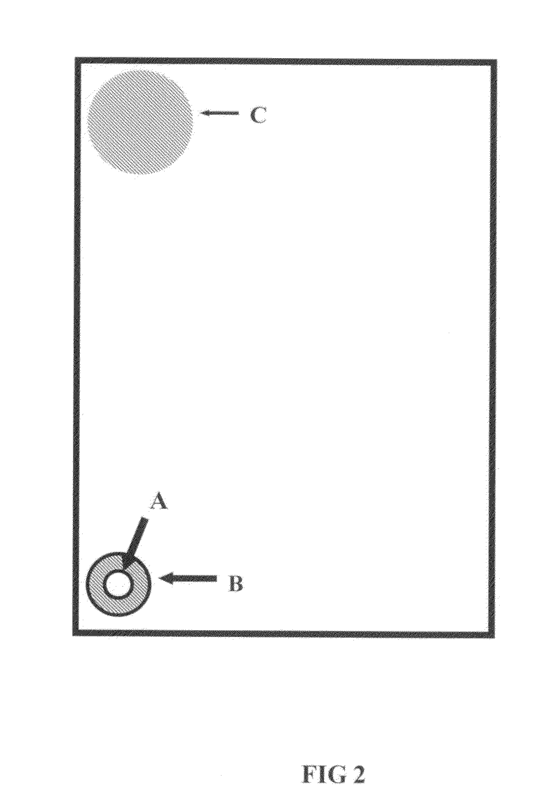

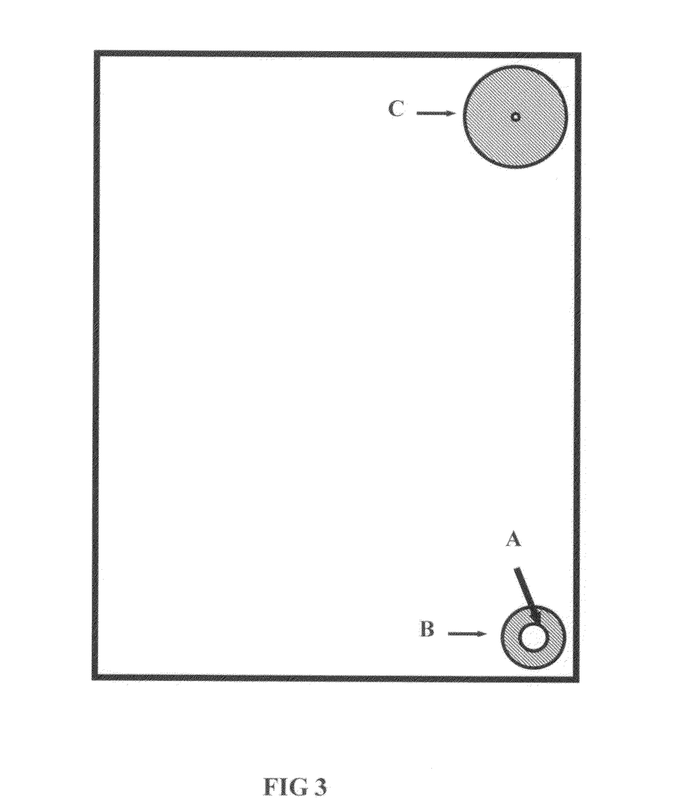

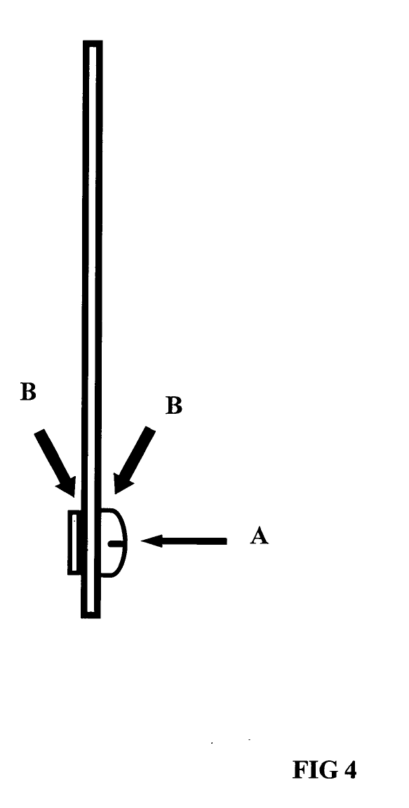

The Seat Saver is illustrated in FIGS. 1-5. It is to be understood that The Seat Saver may be manufactured into different shapes, sizes, and colors to accommodate advertising for the theater.

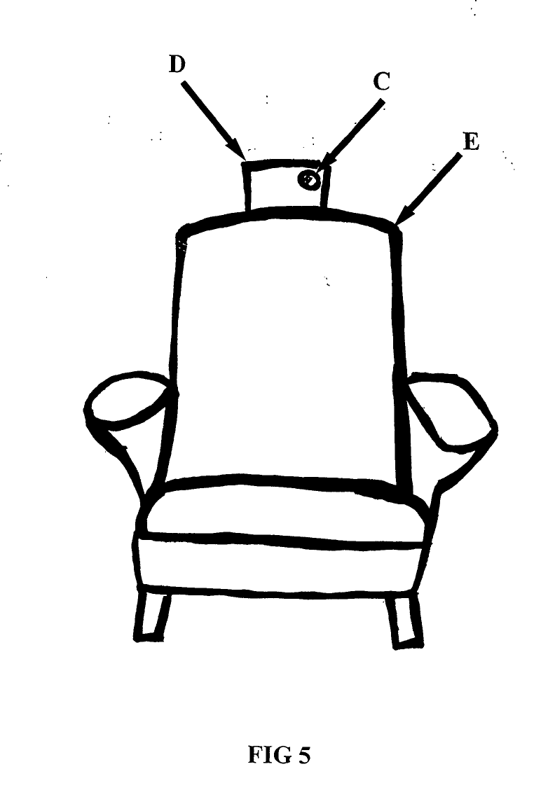

Referring now to FIGS. 1-5, The Seat Saver includes 3 components: one screw A, and two washers B (one in front and one in back of The Seat Saver sign). A hole is also seen in FIGS. 1-5 and is labeled C FIG. 5 shows The Seat Saver sign D attached to the back of a theater seat E, the hole is labeled C, and the sign in the upright position.

1. (canceled)

2. A sign (D) of predetermined size made of plastic that is attached to a theater seat with 1 screw (A) and 2 rubber washers (B) that is raised or lowered whereby indicating that the seat is being saved or is available.

3. The apparatus of claim 2 wherein said screw (A) allows for pivoting the sign and two rubber washers (B) allow for traction in upright or lowered position.

4. The apparatus of claim 3 allows the sign (D) to be unscrewed and changed out regularly to accommodate new advertising signs.
